(19) United States
(12) Patent Application Publication
(10) Pub. No.: US 2011/0063448 A1
(43) Pub. Date: Mar. 17, 2011

(54) Cat 5 Camera System

(76) Inventors: Devin Benjamin, Miami, FL (US); Moshe Luski, Ft. Lauderdale, FL (US)

(21) Appl. No.: 12/883,892

(22) Filed: Sep. 16, 2010

Related U.S. Application Data
(60) Provisional application No. 61/242,867, filed on Sep. 16, 2009.

(51) Int. Cl. H04N 7/18

(52) U.S. Cl. 348/159; 348/E07.085

(57) ABSTRACT

A controller which enables control of the functions and operations of a camera, such as a digital video surveillance camera, by utilization of the menu feature on the camera. For example, by utilizing the menu feature in a digital camera, the lens can be adjusted to control the exposure, the white balance, the backlighting, etc. The controller can control a plurality of cameras and a plurality of controllers can be connected to each other. Each controller will only control the cameras connect to it.

### CROSS REFERENCE TO RELATED APPLICATIONS

This application claims the benefit of priority under U.S.C. 119(e) of U.S. Provisional Patent Application No. 61/242,867, filed Sep. 16, 2009, entitled CAT5 CAMERA SYSTEM, the entirety of which is incorporated herein by reference.

### FIELD OF THE INVENTION

The present invention generally relates to the control of a camera in a system, such as a surveillance CAT5 camera in a surveillance system. In particular, the invention enables control of the camera and control of the camera menu from a location remote of the camera.

### BACKGROUND OF THE INVENTION

Surveillance systems today almost exclusively use digital video cameras. These cameras are mainly utilized for surveillance and for monitoring one or more areas; for example, doorways in hotels and apartment buildings, many areas in sports arenas, most areas in airports, automatic teller machines (ATM), cash registers and point of sale devices (POS), office buildings, factories, casinos, etc. Other uses of these cameras include the monitoring or recording of certain processes or operations such as commercial transactions, sporting events, operations in hospitals, games in casinos, etc.

After Sep. 11, 2001, there has been a substantial increase in many individuals' concern regarding the detection of unauthorized individuals in public and private locations. The military and law enforcement agencies are particularly concerned with the rapid and positive identification of unauthorized individuals in certain locations. The welfare and well being of individuals entrusted to the care of these military and law enforcement personnel is paramount.

### DESCRIPTION OF THE PRIOR ART

While a few surveillance cameras have onboard memory cards or chips, the majority of surveillance cameras are connected to digital video recorders (DVR) or video cassette recorders (VCR) which are capable of providing long term monitoring of particular areas. This long term monitoring can extend from hours to days. The cameras are normally connected to the DVRs or VCRs via co-axial cable such as RG58, RG59 or RG6. In addition to a video signal, audio signals, alarm signals, RS485 data for the camera can be sent through the co-axial cable. Power for the camera can be sent through a power cable.

Surveillance cameras are normally positioned and focused at the time of installation to obtain the maximum coverage or to obtain a specific coverage. Since these cameras are usually in relatively inaccessible locations, it is very difficult to modify the operation and adjust the on screen display function (OSD). A few sophisticated cameras have a pan-tilt-zoom (PTZ) capability under digital electronic control.

The lens of these cameras is mounted such that the center of the field of view can be mechanically pointed at different pan-tilt angles. Further, the images can be optically or digitally zoomed in or out.

### SUMMARY OF THE INVENTION

A camera device which enables control of the functions and operations of a camera, such as a digital video surveillance camera, by utilization of the menu feature on the camera in place of mounted on screen menu buttons. For example, by utilizing the menu feature in a digital camera, the camera can be adjusted for specific operating environments and lighting conditions.

Accordingly, it is an objective of the instant invention to provide remote control of a camera such as a digital camera.

It is a further objective of the instant invention to provide remote control of a digital camera, such as a surveillance camera, by using a CAT5 camera interface.

It is yet another objective of the instant invention to provide a device which enables remote control of a camera and a converter box.

It is a still further objective of the instant invention to provide a device which enables remote control of a camera without specific identification of an individual.

It is still yet another objective of the instant invention to convert protocol built into Digital Video Recorders (DVR) to control the “on screen menu” of the camera.

It is still yet another objective of the instant invention to enable a converter box to communicate with a propriety equipped camera.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a first embodiment of the present invention including a camera and a controller;

FIG. 2 is a Block Diagram of the various items and connections which can be connected to a CAT5 camera interface controller;

FIG. 3 is an example of a CAT5 camera interface controller connected to a camera;

FIG. 4 is an example of a second embodiment of the present invention wherein a plurality of controllers and cameras are employed;

FIG. 5 is an example of another embodiment of the present invention wherein a digital video recorder (DVR) is connected to the controller;

FIG. 6 is an example of a further embodiment of the present invention wherein a circuit board is built into the DVR and replaces a separate controller;

FIG. 7 is an example of a menu which can be used with a camera used to control the operations of another camera;

FIG. 8 is an example of a menu visible within a camera which can be used to control the operations of the camera; and

FIG. 9 is an example of a circuit board of a digital video recorder (DVR) illustrated in FIG. 6.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

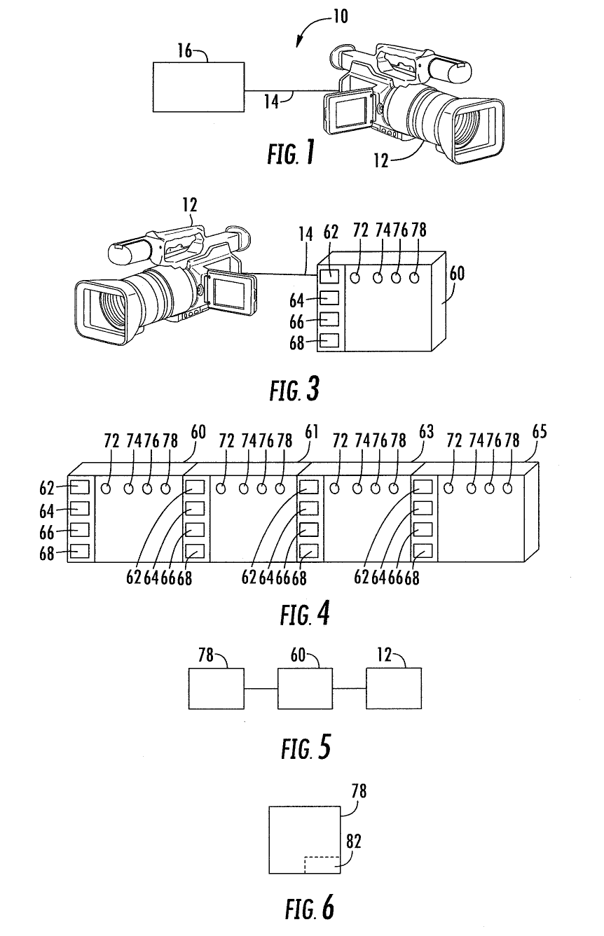

A preferred embodiment of the present invention will now be described with reference to FIGS. 1-9. FIG. 1 illustrates a camera system 10 of the present invention. A camera 12 is connected via an unshielded twisted pair (UTP) cable 14 to a controller 16. The camera is preferably a digital video camera. It can also be any other type of camera which is capable of producing a video image. A UTP cable 14 transmits the video image to the controller 16 where it is processed. The controller can also send signals to the camera 12 to control the functions and power to operate the camera. The UTP cable is preferably one provided with RJ45 connectors at the ends of the UTP cable. These RJ45 connectors are known in the art.

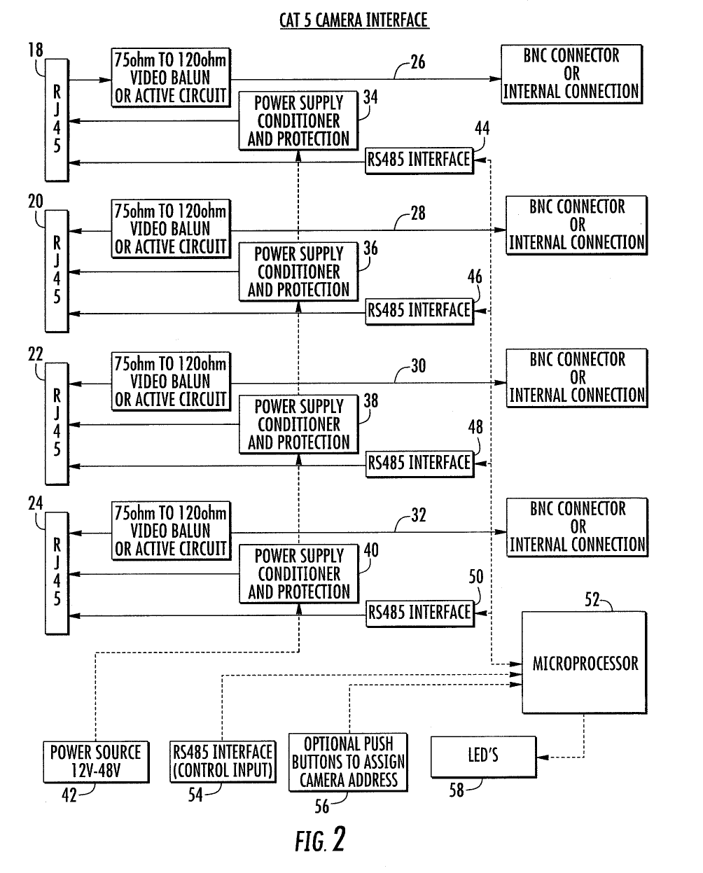

FIG. 2 is a block diagram of the controller 60 of FIG. 3. Four RJ45 connectors 18, 20, 22 and 24 are illustrated. One of the connections 26, 28, 30 and 32 which are connected to each of the connectors 18, 20, 22, and 24 is a 75 ohm to 120 ohm video balun connector or an active circuit. The video balun connector permits both a video signal and power to be run to a CAT-5 camera. The other end of these connections 26, 28, 30 and 32 is provided with a BNC connector or an internal connection. While these specific connectors are employed in the preferred embodiment, other types of connecters can also be employed.

Another item connected to each of the RJ45 connectors is a power supply conditioner or protection 34, 36, 38 and 40. Each of these power supplies is connected in turn to a power source 42. Another item connected to each of the RJ45 connectors is a RS485 interface 44, 46, 48 and 50. These interfaces provide communication with a processor 52. Another RS485 interface 54 is connected between a DVR and the microprocessor 52. While these specific connectors are employed in the preferred embodiment, other types of connecters can also be employed.

Buttons or controls, 72, 74, 76, and 78 (illustrated in FIG. 3) can be provided on the controller 60. These buttons or controls assign specific addresses to various cameras so that the microprocessor 52 can communicate with them. This is illustrated at FIG. 2, 56. Buttons 72, 74, 76 and 78 avoid having to manually set the addresses on each of the cameras using hard to reach DIP switches located on each camera, as required by the prior art systems. Light Emitting Diodes (LED) can be provided on or remote from the microprocessor 52. These LEDs can indicate the various operations of the microprocessor 52 and/or operations of items controlled by the microprocessor 52.

FIG. 3 illustrates a preferred embodiment of the present invention. A controller 60 is connected to a camera 12 via a UTP cable 14. The cable is connected to port 62 at one end and the camera 12 at its other end. The controller 60 is provided with four ports 62, 64, 66 and 68. These ports enable up to four separate cameras to be connected to controller 60. The number of ports can be from one to an infinite number. Thus the number of cameras that can be controlled by one controller is very large. A UTP cable 14 can be connected to each of these ports individually. Buttons 72, 74, 76, and 78 are positioned at the front of the controller 60. Whenever a connection is to be established or reestablished between the controller 60 and the camera 12, the UTP cable 14 is inserted into one of the ports 62, 64, 66 or 68 and a button 72, 74, 76 or 78 corresponding to an individual controller 60 is pushed. For example, when cameras are connected to the controller 60, the cable 14 is inserted into port 62, and button 72 is pushed to activate the connection. When a cable 14 from a second camera is inserted into port 64, button 72 is pushed to activate the connection. When a cable 14 from a third camera is inserted into port 66, button 72 is pressed to activate the connection.

FIG. 4 illustrates an embodiment wherein a plurality of controllers 60 are connected to one another. When a second controller 61 is utilized up to four cameras, in this particular embodiment, can be connected to the controller 61 by ports 62, 64, 66 and 68. To activate the controller and synchronize the cameras to controller 61, button 74 on controller 61 is pressed. In this manner the second group of cameras connected to controller 61 is controlled by controller 61 only. In the event that a third controller 63 is utilized, the cameras are connected to ports 62-68 and button 76 is pressed to activate the controller and synchronize the cameras to controller 63. In this manner the third group of cameras connected to controller 63 is controlled by controller 63 only. If a fourth controller 65 were utilized the connections would be similar except that button 78 would be pressed to synchronize the cameras to controller 65. As many controllers and cameras as necessary could be employed. They would be connected to each other in the manner described above.

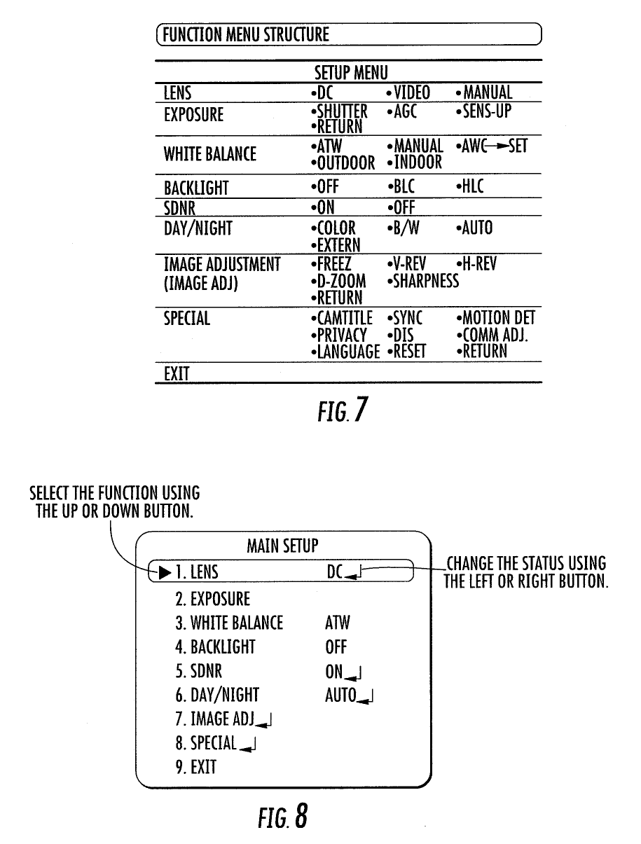

FIG. 5 is an example of another embodiment of the present invention wherein a DVR 78 is connected to a controller 60 which in turn is connected to a camera 12.

FIG. 6 illustrates another embodiment wherein a circuit board 82 is built into the DVR and replaces a separate controller 60.

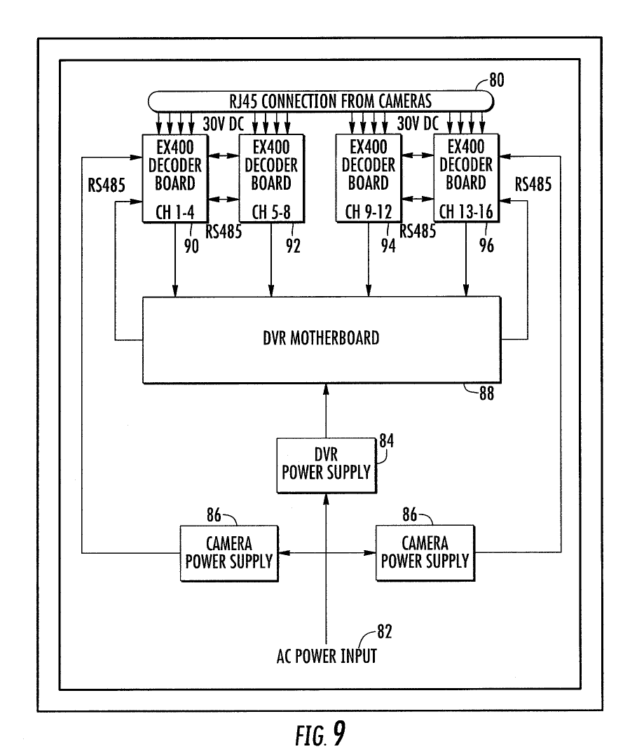

FIGS. 7 and 8 illustrate typical menus associated with a digital camera. The different adjustments illustrated in FIGS. 7 and 8 can be changed to other in the present invention. For example, the “lens” adjustments (FIG. 8) can be changed. The “White Balance” and “Backlight” adjustments (FIG. 8) can be changed.

FIG. 9 is an example of a circuit board in a DVR which is configured to control a plurality of video cameras connected to the DVR. Connector 80 is a single connector to which a plurality of video cameras are connected, or a plurality of connectors similar to connectors 18, 20, 22 and 24 in FIG. 2. A power supply 82 is connected to the DVR. The power supply 82 provides power to both the DVR through DVR power supply 84 and the video cameras power supply 86. Power is supplied to the video cameras from power supply 86 through the connector 80. The DVR includes a mother board 88 which includes all of the components that control the operation of the DVR. Decoder boards 90, 92, 94, and 96 are in communication with the DVR mother board. The decoder boards coordinate the operation of the various channels through which the video cameras communicate with the DVR. The controller boards can set the addresses of each of the different video cameras connected to the DRV so as to enable the operation of all of the video cameras to be coordinated by and through a single video camera connected to the DVR. For example, decoder board 90 coordinates channels 1-4, decoder board 92 coordinates channels 5-8, decoder board 94 coordinates channels 9-12 and decoder board 96 coordinates channels 13-16. While only four decoder boards are illustrated, any number can be employed. A microprocessor similar to microprocessor 52 in FIG. 2 can be connected to the DVR to operate the video cameras.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for operation of a plurality of video cameras comprising:
at least two video cameras connected to a controller;
a power supply connected to said controller; and
said controller coordinating the operation of all of the video cameras connected thereto, whereby when the function of one said video camera is activated, the same function of all of said video cameras connected to said controller is activated.

2. The system of claim 1 wherein said controller includes a control which sets an address for each said video camera connected to said connector whereby a computer can communicate with each said video camera individually.

3. The system of claim 2 including a computer connected to and communication with said video cameras through said controller.

4. The system of claim 1 including a cable connecting said video camera to said connector, said connector constructed and arranged to simultaneously transmit video signals and electrical power to said video cameras.

5. The system of claim 1 including a plurality of controllers serially connected to each other.

6. The system of claim 5 including controls on each of said controllers, said controls synchronizing a plurality of said video cameras connected to a single said controller, whereby said video cameras connected to different said controllers will not be synchronized to each other.

7. The system of claim 6 including a computer connected to and communication with said video cameras through said controllers.

8. The system of claim 1 wherein the function of the lens of each said video cameras connected to said controller is activated from said one video camera.

9. The system of claim 1 where the position of each of said video cameras connected to said controller is changed by said one video camera.

10. The system of claim 1 including a digital video recorder connected to said video cameras, said digital video recorder including a control which sets an address for each of said video cameras connected to said digital video recorder.

11. The system of claim 10 including a computer connected to and communication with said video cameras through said digital video recorder.

12. The system of claim 10 including a plurality of decoder boards connected to each other.

13. The system of claim 12 including controls operating each of said decoder boards, said controls synchronizing a plurality of said video cameras connected to a single said decoder board, whereby said video cameras connected to different said decoder boards will not be synchronized to each other.
